(19) United States
(12) Patent Application Publication
(10) Pub. No.: US 2012/0183879 A1
(43) Pub. Date: Jul. 19, 2012

(54) MEMBRANE ELECTRODE ASSEMBLY AND FUEL CELL USING THE SAME

(76) Inventors: Saori OKADA, Tokyo (JP); Haruna KURATA, Tokyo (JP); Hiroyuki MORIOKA, Tokyo (JP); Kenichiro OOTA, Kanagawa (JP)

(21) Appl. No.: 13/433,222

(22) Filed: Mar. 28, 2012

Related U.S. Application Data
(63) Continuation of application No. PCT/JP10/54378, filed on Mar. 16, 2010.

(30) Foreign Application Priority Data
Sep. 29, 2009 (JP) 2009-223803

(51) Int. Cl. H01M 8/10; H01M 4/90; B82Y 30/00

(52) U.S. Cl. 429/480; 977/773

(57) ABSTRACT

The present invention provides a fuel cell and a membrane electrode assembly thereof employing an electrode catalyst layer which contains an oxide type of non-platinum catalyst as the catalyst and enables the fuel cell to achieve a high level of power generation performance. One aspect of the present invention is the electrode catalyst layer containing a polymer electrolyte, a catalyst and an electron conductive material, wherein a content ratio by weight of the catalyst is in the range of 0.1-3.0 with respect to 1.0 of the electron conductive material and a content ratio by weight of the polymer electrolyte is in the range of 0.5-3.0 with respect to 1.0 of the electron conductive material.

This application is a continuation of International Application No. PCT/JP2010/054378, filed Mar. 16, 2010, which is incorporated herein by reference in its entirety.

### BACKGROUND OF THE INVENTION

1. Field of the Invention

The present invention relates to a membrane electrode assembly (MEA) and a fuel cell which include the MEA. In particular, the present invention relates to an MEA for a proton exchange membrane fuel cell (PEMFC) or polymer electrolyte fuel cell (PEFC) as well as a PEMFC or PEFC which uses the MEA.

2. Description of the Related Art

A fuel cell is a power generation system in which a fuel gas including hydrogen and an oxidant gas including oxygen react together so that a reverse reaction of water electrolysis takes place. A fuel cell is attracting attention as a clean energy source of the future because of advantages such as high efficiency, a small impact on the environment and a low level of noise relative to conventional power generation systems. Fuel cells are classified into several types according to an electrolyte employed therein. A molten carbonate fuel cell (MCFC), a phosphoric-acid fuel cell (PAFC), a solid-oxide fuel cell (SOFC), and a PEMFC or PEFC etc. are examples of the types of fuel cells.

Among various fuel cells, a PEMFC (or PEFC), which can be used at around room temperature, is regarded as a promising fuel cell for use in vehicles and household stationary power supply etc. and is being developed widely in recent years. In the PEMFC (or PEFC), a joint unit which has a pair of electrode catalyst layers on both sides of a polymer electrolyte membrane and is called a membrane electrode assembly (MEA) is arranged between a pair of separators, on each of which either a gas flow path for supplying a fuel gas including hydrogen to one of the electrodes or a gas flow path for supplying an oxidant gas including oxygen to the other electrode is formed. The electrode for supplying a fuel gas is called a fuel electrode or anode whereas the electrode for supplying an oxidant gas is called an air electrode or cathode. In general, each of these electrodes includes an electrode catalyst layer, in which a polymer electrolyte(s) and catalyst loaded carbon particles are stacked, and a gas diffusion layer which has gas permeability and electron conductivity. A noble metal etc. such as platinum is used as the catalyst.

Apart from other problems such as improving durability and output density etc., cost reduction is the most major problem for putting the PEMFC (or PEFC) into practical use.

Since the PEMFC (or PEFC) at present employs expensive platinum as the electrode catalyst, an alternate catalyst material is strongly desired to fully promote the PEMFC (or PEFC). As more platinum is used in the air electrode than in the fuel electrode, an alternative to platinum (namely, a non-platinum catalyst) with a high level of catalytic performance for oxygen-reduction on the air electrode is particularly well under development.

A mixture of a noble metal and nitride of iron (a transition metal) described in Patent document 1 is an example of a non-platinum catalyst for the air electrode. In addition, a nitride of molybdenum (a transition metal) described in Patent document 2 is another example. These catalyst materials, however, have an insufficient catalytic performance for oxygen-reduction in an acidic electrolyte and are dissolved in some cases.

On the other hand, Non-patent document 1 reports that a partially-oxidized tantalum carbonitride has both excellent stability and catalytic performance. It is true that this oxide type non-platinum catalyst has a high level of catalytic performance for oxygen-reduction in itself but it remains necessary to develop an appropriate method to make it into the electrode catalyst layer because the catalyst is not loaded on carbon particles unlike platinum catalyst and has low electron conductivity.

Moreover, Patent document 3 describes an MEA employing a non-platinum catalyst. In Patent document 3, however, there is such a problem that a method to make the non-platinum catalyst into an electrode catalyst layer is not suitable for a non-platinum catalyst since it is a method which is described, for example, in Patent document 4 and Patent document 5 etc. and is conventionally used for platinum catalyst.

<Patent document 1>: JP-A-2005-44659.

<Patent document 2>: JP-A-2005-63677.

<Patent document 3>: JP-A-2008-270176.

<Patent document 4>: JP-B-H02-48632 (JP-A-H01-62489).

<Patent document 5>: JP-A-H05-36418.

<Non-patent document 1>: “Journal of The Electrochemical Society”, Vol. 155, No. 4, pp. B400-B406 (2008).

### SUMMARY OF THE INVENTION

The present invention aims to solve problems of conventional techniques. The present invention provides an MEA and a fuel cell which employ an electrode catalyst layer, the electrode catalyst layer having a polymer electrolyte, a catalyst material and an electron conductive material, and the electrode catalyst layer having an improved output performance using an oxide type of non-platinum catalyst as the catalyst material.

After eager research to solve various problems, the inventors completed the present invention.

A first aspect of the present invention is a membrane electrode assembly including: a polymer electrolyte membrane, a pair of electrode catalyst layers, and a pair of gas diffusion layers, wherein the polymer electrolyte membrane is interposed between the pair of electrode catalyst layers and the pair of electrode catalyst layers are interposed between the pair of gas diffusion layers, wherein at least one of the pair of electrode catalyst layers contains an electron conductive material, a catalyst and a polymer electrolyte, and wherein at least in one of the pair of electrode catalyst layers, a content ratio by weight of the catalyst is in the range of 0.1-3.0 with respect to 1.0 of the electron conductive material and a content ratio by weight of the polymer electrolyte is in the range of 0.5-3.0 with respect to 1.0 of the electron conductive material.

A second aspect of the present invention is the membrane electrode assembly according to the first aspect of the present invention, wherein the catalyst has a specific surface area in the range of 1-100 m²/g and an average particle diameter in the range from 20 nm to 3.0 μm.

A third aspect of the present invention is the membrane electrode assembly according to the second aspect of the present invention, wherein the catalyst contains at least one transition metal of the group of Ta, Nb, Ti and Zr.

A fourth aspect of the present invention is the membrane electrode assembly according to the third aspect of the present invention, wherein the catalyst is a product made by partially-oxidizing a carbonitride of one transition metal of the group of Ta, Nb, Ti and Zr in the presence of oxygen.

A fifth aspect of the present invention is the membrane electrode assembly according to the fourth aspect of the present invention, wherein the one transition metal is Ta.

A sixth aspect of the present invention is a fuel cell including the membrane electrode assembly according to the fifth aspect of the present invention.

A seventh aspect of the present invention is the membrane electrode assembly according to the third aspect of the present invention, wherein the electron conductive material has a specific surface area in the range of 100-2000 m²/g and an average particle diameter in the range of 20-100 nm.

An eighth aspect of the present invention is the membrane electrode assembly according to the seventh aspect of the present invention, wherein the electron conductive material is carbon particles.

A ninth aspect of the present invention is a fuel cell including the membrane electrode assembly according to the eighth aspect of the present invention.

According to the present invention, it is possible to improve electron conductivity and proton conductivity on a surface of a catalyst in the electrode catalyst layer which contains the catalyst, a polymer electrolyte and an electron conductive material. They are improved by controlling a content ratio between the catalyst and the electron conductive material and a content ratio between the polymer electrolyte and the electron conductive material in the electrode catalyst layer. As a result, since active reaction sites are increased in the electrode catalyst layer, an MEA and a fuel cell with a high level of output performance can be obtained.

### BRIEF DESCRIPTION OF THE DRAWINGS

FIG. 1 is a cross sectional schematic diagram of an MEA of an embodiment of the present invention.

FIG. 2 is an exploded schematic diagram of a fuel cell of an embodiment of the present invention.

FIG. 3 is a graph showing power generation performance of fuel cells which employ MEAs of the Examples and Comparative example of the present application.

### DESCRIPTION OF NUMERALS

1: Polymer electrolyte membrane

2: Electrode catalyst layer (on air electrode)

3: Electrode catalyst layer (on fuel electrode)

4: Gas diffusion layer (on air electrode)

5: Gas diffusion layer (on fuel electrode)

6: Air electrode (Cathode)

7: Fuel electrode (Anode)

8: Gas flow path

9: Cooling water flow path

10: Separator

12: Membrane electrode assembly (MEA)

13: Fuel cell (PEMFC or PEFC)

### EMBODIMENT OF THE INVENTION

An MEA and a fuel cell of an embodiment of the present invention are described below. Embodiments of the present invention are not fully limited to the embodiment of the present invention described below since the embodiment can be modified, redesigned, changed, and/or added with details etc. according to any knowledge of a person in the art so that the scope of the embodiment of the present invention is expanded.

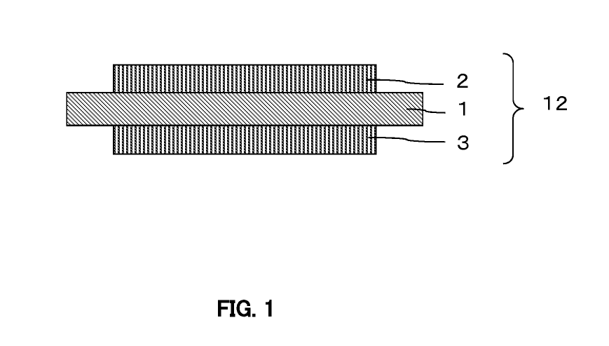

FIG. 1 illustrates a concise cross section diagram of an MEA 12 of an embodiment of the present invention. The MEA 12 of the embodiment of the present invention has a polymer electrolyte membrane 1, an electrode catalyst layer (of an air electrode) 2 on a surface of the polymer electrolyte membrane 1, and an electrode catalyst layer (of a fuel electrode) 3 on the other surface of the polymer electrolyte membrane 1, as is shown in FIG. 1. In addition, although not illustrated in FIG. 1, a gas diffusion layer of the air electrode is arranged on the electrode catalyst layer 2 while a gas diffusion layer of the fuel electrode is arranged on the electrode catalyst layer 3.

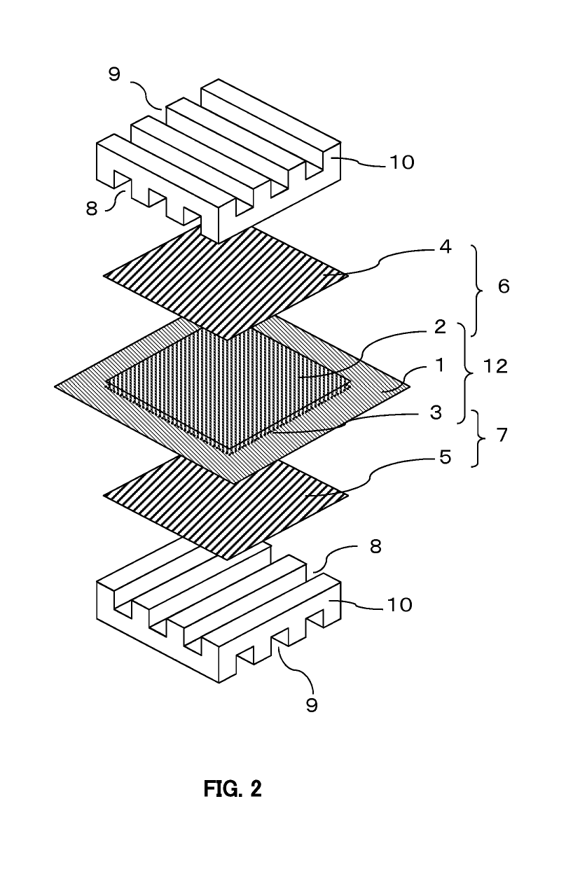

Next, a fuel cell which employs the MEA of the embodiment of the present invention is described. FIG. 2 illustrates an exploded exemplary diagram of a fuel cell of an embodiment of the present invention. In a fuel cell 13 of the embodiment of the present invention, a gas diffusion layer (of the air electrode) 4 and a gas diffusion layer (of the fuel electrode) 5 are arranged respectively facing the electrode catalyst layer (of the air electrode) 2 and electrode catalyst layer (of the fuel electrode) 3, which are disposed on both surfaces of the polymer electrolyte 1. This is a structure of the air electrode (cathode) 6 and the fuel electrode (anode) 7. Moreover, a pair of separators 10 is arranged in the fuel cell, wherein each separator 10 is made of a conductive and impermeable material and has a gas flow path 8 for transporting a gas on one surface and a cooling water path 9 for transporting cooling water on the opposite surface. A fuel gas such as hydrogen gas for example, is supplied through the gas flow path 8 on the separator 10 of the fuel electrode 7 whereas an oxidant gas such as a gas containing oxygen for example is supplied through the gas flow path 8 on the separator 10 of the air electrode 6.

As is shown in FIG. 2, the fuel cell 13 of the embodiment of the present invention is one of a so-called “unit cell” structured fuel cell, in which the polymer electrolyte membrane 1, the electrode catalyst layers 2 and 3, and the gas diffusion layers 4 and 5 are interposed between the pair of separators 10, while the present invention also includes a fuel cell in which a plurality of unit cells are stacked via separators 10.

In a manufacturing method of an electrode catalyst layer of the present invention, it is possible to desirably arrange an electron conductive material and a polymer electrolyte on a surface of a catalyst by controlling each content ratio of the catalyst and the polymer electrolyte with respect to the electron conductive material so that electron conductivity and proton conductivity are improved on the catalyst surface. As a result, as active reaction sites are increased in the electrode catalyst layer, an MEA and a fuel cell having a high level of output performance can be obtained.

In the manufacturing method of the electrode catalyst layer of the present invention, it is preferable that while the electrode catalyst layer contains the polymer electrolyte, the catalyst and the electron conductive material, the content ratio by weight of the catalyst is in the range of 0.1-3.0 with respect to 1.0 of the electron conductive material, and the content ratio by weight of the polymer electrolyte is in the range of 0.5-3.0 with respect to 1.0 of the electron conductive material. It is more preferable that the content ratio by weight of the catalyst is in the range of 0.1-0.9 with respect to 1.0 of the electron conductive material, and the content ratio by weight of the polymer electrolyte is in the range of 1.0-2.0 with respect to 1.0 of the electron conductive material. In the case where the content ratio of the catalyst to the electron conductive material is higher than 3.0, resistance becomes high because it is impossible to sufficiently arrange the electron conductive material on the catalyst surface thereby inhibiting electron conduction. On the other hand, in the case where the content ratio of the catalyst to the electron conductive material is lower than 0.1, while an excessive electrolyte, which has no contact with the catalyst surface, is useless for increasing active reaction sites, output performance is not improved because gases do not easily diffuse as an entire volume of the electrode catalyst layer is expanded. In the case where the content ratio of the polymer electrolyte to the electron conductive material is lower than 0.5, proton conductivity becomes insufficient. In the case where the content ratio of the polymer electrolyte to the electron conductive material is higher than 3.0, pores in the electrode catalyst layer are filled up with the polymer electrolyte thereby inhibiting gas diffusion, and further, possibly causing a phenomenon called flooding, by which water produced by power generation accumulates within the electrode catalyst layer.

It is possible to use a generally-used catalyst material as the catalyst of the embodiment of the present invention. In the manufacturing method of the electrode catalyst layer of the present invention, it is preferable that the catalyst has a specific surface area in the range of 1-100 m²/g and an average particle size (diameter) in the range from 20 nm to 3 μm. In the case where the catalyst has an average particle size (diameter) greater than 3 μm, electron conduction is inhibited since it is impossible to arrange sufficient electron conductive material on the catalyst surface. On the other hand, in the case where the catalyst has an average particle size (diameter) smaller than 20 nm, the electron conductive material cannot contact the catalyst surface and becomes excessive, namely it does not serve to increase active reaction sites, in the electrode catalyst layer. In the case where the catalyst has a specific surface area outside of the range of 1-100 m²/g, it is impossible to adjust the content ratio of the polymer electrolyte in the electrode catalyst layer to within the desirable range.

It is possible, with respect to the catalyst in the present invention, to use, for example, a positive electrode active material of PEMFC which contains at least one transition metal selected from the group of Ta, Nb, Tl and Zr, as an alternative to platinum in the air electrode. In addition, more preferably, it is possible to use a carbonitride of these transition metals which is partially oxidized in an atmosphere including oxygen as the catalyst.

Specifically, a material obtained by partial oxidation of tantalum carbonitride (TaCN), that is TaCNO, which has a specific surface area in the range of about 1-20 m²/g is included in such carbonitrides.

It is possible to use carbon particles as the electron conductive material of the embodiment of the present invention. Any carbons which are in shape of particles, electrically conductive and unreactive with the catalyst can be used as the carbon particles of the embodiment of the present invention. For example, carbon blacks, graphites, black leads, active carbons, carbon fibers, carbon nano-tubes and fullerenes can be used. It is preferable that the carbon particles have an average particle size (diameter) in the range of 10-2000 nm because electron conduction paths are hardly formed when the size is smaller than 10 nm while gases are not easily diffused in the electrode catalyst layer and the catalyst is used at a lower efficiency when the size is greater than 2000 nm. It is more preferable that the average particle size (diameter) is in the range of 20-100 nm. In addition, it is preferable that the electron conductive material has a specific surface area in the range of 100-2000 m²/g. In the case where the electron conductive material has a specific surface area smaller than 100 m²/g, electron conduction is inhibited since it is impossible to arrange sufficient electron conductive material on the catalyst surface. On the other hand, in the case where the electron conductive material has a specific surface area greater than 2000 m²/g, the electron conductive material cannot contact the catalyst surface and becomes excessive, namely it does not serve to increase active reaction sites, in the electrode catalyst layer.

Next, MEA 12 and the fuel cell 13 of the present invention are described in detail below.

Firstly, a polymer electrolyte membrane 1 is prepared as illustrated in FIG. 1. Any material having proton conductivity and no (a significantly low level of) electron conductivity may be used as the polymer electrolyte membrane 1. In particular, a perfluorosulfonate membrane, for example, Nafion® (made by Du Pont), Flemion® (made by ASAHI GLASS CO., LTD.), Aciplex® (made by Asahi KASEI Cooperation), and Gore Select® (by Japan Gore-Tex Inc.) etc. can be used. Besides these, hydrocarbon resins which contain a proton conductive group, for example, polyimides etc. may be used.

It is preferable that the same material used as the polymer electrolyte in the electrode catalyst layers 2 and 3 is employed as the polymer electrolyte membrane 1 of the embodiment of the present invention.

Next, the electrode catalyst layer 2 and the electrode catalyst layer 3 are formed on both surfaces of the polymer electrolyte membrane 1. A catalyst ink which contains the polymer electrolyte, the catalyst, the electron conductive material and a solvent is prepared for forming the electrode catalyst layers 2 and 3.

A wide variety of materials can be used as the polymer electrolyte contained in the catalyst ink. It is preferable that the same polymer electrolyte as the polymer electrolyte membrane 1 is used for the catalyst ink. In the case where Nafion® made by Du Pont is used as the polymer electrolyte membrane 1, it is preferable that Nafion® is used as the polymer electrolyte contained in the catalyst ink. In the case where another polymer electrolyte is used as the polymer electrolyte membrane 1, it is preferable that the same polymer electrolyte is contained in the catalyst ink.

A solvent in which the proton conductive polymer electrolyte is dissolved with high fluidity or dispersed as a fine gel and yet in which the catalyst and the proton conductive polymer electrolyte membrane do not corrade can be used as a solvent of the catalyst ink. It is preferable that the solvent contains at least one volatile organic solvent. For example, alcohol solvents such as methanol, ethanol, 1-propanol, 2-propanol, 1-butanol, 2-butanol, isobutyl alcohol, tert-butyl alcohol, pentanol, 2-heptanol and benzyl alcohol etc., ketone solvents such as acetone, methyl ethyl ketone, methyl propyl ketone, methyl butyl ketone, methyl isobutyl ketone, methyl amyl ketone, pentanone, heptanone, cyclohexanone, methyl cyclohexanone, acetonyl acetone, diethyl ketone, dipropyl ketone and diisobutyl ketone etc., ether solvents such as tetrahydrofuran, tetrahydropyran, dioxane, diethylene glycol dimethyl ether, anisole, methoxytoluene, diethyl ether, dipropyl ether and dibutyl ether etc., amine solvents such as isopropylamine, butylamine, isobutylamine, cyclohexylamine, diethylamine and aniline etc., ester solvents such as propyl formate, isobutyl formate, amyl formate, methyl acetate, ethyl acetate, propyl acetate, butyl acetate, isobutyl acetate, pentyl acetate, isopentyl acetate, methyl propionate, ethyl propionate and butyl propionate etc. and other polar solvents such as acetic acid, propionic acid, dimethylformamide, dimethylacetamide, N-methylpyrrolidone, ethylene glycol, diethylene glycol, propylene glycol, ethylene glycol monomethyl ether, ethylene glycol dimethyl ether, ethylene glycol diethyl ether, diacetone alcohol and 1-methoxy-2-propanol etc. may be used as the solvent of the catalyst ink. In addition, any solvent mixture of a combination of a plurality of these solvents may also be used as the solvent.

It is possible to control a dispersion state of the polymer electrolyte in the catalyst ink by blending two of these solvents having a different permittivity. In addition, the solvent may contain water, in which the polymer electrolyte is highly soluble. When using solvents of a lower alcohol as the solvent, a mixture with water is preferably used since a lower alcohol has a high risk of igniting. There is no particular limitation to a water additive amount unless the polymer electrolyte is separated from the solvent to generate white turbidity or turn into a gel.

In addition, a dispersant may be contained in the catalyst ink in order to improve stability. An anion surfactant, a cation surfactant, an amphoteric (or ampholytic) surfactant and a non-ionic surfactant etc. can be used as the dispersant.

In addition, the catalyst ink may include a pore forming agent. Fine pores are created by removing the pore forming agent after the electrode catalyst is formed. Examples of the pore forming agent are materials soluble in acid, alkali or water, sublimation materials such as camphor, and materials which decompose by heat. If the pore former is soluble in warm water, it can be removed by water produced during the power generation.

For example, inorganic salts (soluble to acid) such as calcium carbonate, barium carbonate, magnesium carbonate, magnesium sulfate, and magnesium oxide etc., inorganic salts (soluble to alkali aqueous solution) such as alumina, silica gel, and silica sol etc., metals (soluble to acid and/or alkali) such as aluminum, zinc, tin, nickel, and iron etc., inorganic salts (soluble to water) aqueous solutions of sodium chloride, potassium chloride, ammonium chloride, sodium carbonate, sodium sulfate, and monobasic sodium phosphate etc., and water soluble organic compounds such as polyvinyl alcohol, and polyethylene glycol etc. can be used as the pore forming agent soluble in acid, alkali or water. Not only a single material but a plurality of these together can be effectively used.

It is preferable that the catalyst ink has viscosity in the range of 0.1-100 cP. The viscosity can be optimized by selecting the solvent and/or controlling a solid content amount. An addition of a dispersant in preparation of the catalyst ink is also useful to control the viscosity.

In addition, the catalyst ink containing the polymer electrolyte, the catalyst, the electron conductive material and the solvent receives a dispersion treatment in a conventional method if necessary.

The polymer electrolyte membrane and each of the electrode catalyst layers 2 and 3 are jointed together to form an MEA 12 by thermocompression. In addition, it is possible to coat a solution containing a proton conductive polymer as an adhesive agent between each electrode catalyst layer and the polymer electrolyte membrane 1.

With regards to the gas diffusion layers 4 and 5, and separators 10 in the fuel cell of the embodiment of the present invention, it is possible to employ products normally used in a conventional fuel cell. Specifically, a carbon cloth, a carbon paper and a porous carbon such as unwoven carbon fabric can be used as the gas diffusion layers 4 and 5. A carbon separator and a metal separator etc. can be used as the separators 10. In addition, the fuel cell of the present invention can be fabricated by joining additional equipment such as gas supply equipment and cooling equipment etc. to the MEA 12 having such components described above.

### EXAMPLES

Specific examples of an MEA of the present invention and a comparative example will be described below. The present invention, however, is not limited by the examples below.

### Example 1

### Preparing Catalyst Ink

Partially-oxidized tantalum carbonitride (TaCNO, specific surface area: 9 m²/g) as a catalyst, Ketjen Black (product code: EC-300J, made by Lion Corporation, specific surface area: 800 m²/g, average particle size (diameter): 50 nm) as an electron conductive material and a 20% by weight solution (solvent: IPA, ethanol and water) of a polymer electrolyte (Nafion®, made by DuPont) were mixed together followed by performing a dispersion treatment using a planetary ball mill (product code: P-7, by Fritsch Japan Co., Ltd). A zirconia pot and zirconia balls were used for the ball mill. The resultant catalyst ink 1 had a composition ratio of 0.5:1 by weight between the catalyst and the electron conductive material. Furthermore, resultant catalyst ink 1 had a composition ratio of 0.8:1 by weight between the polymer electrolyte and the electron conductive material.

### Forming an Electrode Catalyst Layer (Sheet 1) for an Air Electrode

The catalyst ink 1 was coated on a PTFE substrate by a doctor blade and dried under atmosphere at 80° C. for five minutes. An electrode catalyst layer 2 (sheet 1) for an air electrode was formed by adjusting the thickness in such a way that an amount of the catalyst which was contained in the layer in all was 0.4 mg/cm².

### Example 2

### Preparing Catalyst Ink 2

Partially-oxidized tantalum carbonitride (TaCNO, specific surface area: 9 m²/g) as a catalyst, Ketjen Black (product code: EC-300J, made by Lion Corporation, specific surface area: 800 m²/g, average particle size (diameter): 50 nm) as an electron conductive material and a 20% by weight solution (solvent: IPA, ethanol and water) of a polymer electrolyte (Nafion®, made by DuPont) were mixed together followed by performing a dispersion treatment using a planetary ball mill (product code: P-7, by Fritsch Japan Co., Ltd). A zirconia pot and zirconia balls were used for the ball mill. The resultant catalyst ink 2 had a composition ratio of 1:1 by weight between the catalyst and the electron conductive material. Furthermore, resultant catalyst ink 2 had a composition ratio of 0.8:1 by weight between the polymer electrolyte and the electron conductive material.

### Forming an Electrode Catalyst Layer (Sheet 2) for an Air Electrode

The catalyst ink 2 was coated on a PTFE substrate by a doctor blade and dried under atmosphere at 80° C. for five minutes in the same way as in Example 1. An electrode catalyst layer 2 (sheet 2) for an air electrode was formed by adjusting the thickness in such a way that an amount of the catalyst which was contained in the layer in all was 0.4 mg/cm².

### Example 3

### Preparing Catalyst Ink 3

A catalyst ink 3 was prepared in a similar way to that in Example 1 and Example 2. The resultant catalyst ink 3 had a composition ratio of 2:1 by weight between the catalyst and the electron conductive material. Furthermore, resultant catalyst ink 3 had a composition ratio of 0.8:1 by weight between the polymer electrolyte and the electron conductive material.

### Forming an Electrode Catalyst Layer (Sheet 3) for an Air Electrode

The catalyst ink 3 was coated on a PTFE substrate by a doctor blade and dried under atmosphere at 80° C. for five minutes in the same way as in Example 1 and Example 2. An electrode catalyst layer 2 (sheet 3) for an air electrode was formed by adjusting the thickness in such a way that an amount of the catalyst which was contained in the layer in all was 0.4 mg/cm².

### Comparative Example

### Preparing Catalyst Ink 4

A catalyst ink 4 was prepared in the same way to that in the Examples described above except that the resultant catalyst ink 4 had a composition ratio of 4:1 by weight between the catalyst and the electron conductive material. The catalyst ink 4 was coated on a PTFE substrate by a doctor blade and dried under atmosphere at 80° C. for five minutes in the same way as in the Examples. An electrode catalyst layer (sheet 4) for an air electrode was formed by adjusting the thickness in such a way that an amount of the catalyst which was contained in the layer in all was 0.4 mg/cm².

### Forming an Electrode Catalyst Layer for a Fuel Electrode

An electrode catalyst layer for a fuel electrode is formed as described below with respect to the Examples 1 to 3 and Comparative example. A catalyst of “platinum loaded carbon particles” (amount of loaded platinum: 50% by weight to the whole, product code: TEC10E50E, made by Tanaka Kikinzoku Kogyo K.K.) and a 20% by weight solution (solvent: IPA, ethanol and water) of a polymer electrolyte (Nafion®, made by DuPont) were mixed together in a solvent followed by performing a dispersion treatment by a planetary ball mill (product code: P-7, by Fritsch Japan Co., Ltd). The dispersion treatment was performed for 60 minutes. The resultant catalyst ink had a composition ratio of 1:1 by weight between the carbons, which is an electron conductive material, in the “platinum loaded carbon particles” and the polymer electrolyte. A solvent mixture of 1:1 by volume of ultrapure water and 1-propanol was used as the solvent. The resultant catalyst ink had 10% by weight of solid content. The catalyst ink was coated on a PTFE substrate and dried in a similar way to the case of the electrode catalyst layer 2 for the air electrode. The electrode catalyst layer 3 for the fuel electrode was formed by adjusting the thickness in such a way that an amount of the catalyst which was loaded on the layer in all was 0.3 mg/cm².

### Fabricating a Membrane Electrode Assembly

Each of the sheets 1-4 on which the electrode catalyst layer 2 for the air electrode was formed described in the Examples 1-3 and Comparative example and the sheet on which the electrode catalyst layer 3 for the fuel electrode was formed described above were respectively stamped out in a shape of 5 cm² square and arranged facing both surfaces of a polymer electrolyte membrane (Nafion®212, made by DuPont). Subsequently, hot pressing was performed at 130° C. for ten minutes to obtain an MEA 12. After arranging a pair of carbon cloths having a filler layer as gas diffusion layers 4 and 5 on both surfaces, the resultant MEA 12 was further interposed between a pair of separators 10 so that a single cell of PEMFC or PEFC was fabricated.

### Power Generation Performance

### Measurement

Power generation performance was measured under a condition of 80° C. cell temperature and 100% RH (relative humidity) both in an anode and cathode using a fuel cell test apparatus GFT-SG1 made by Toyo Corporation. Pure hydrogen as a fuel gas and pure oxygen as an oxidant gas were used and controlled to flow at a constant rate. Back pressures on the anode (fuel electrode) side and the cathode (air electrode) side were 200 kPa and 300 kPa, respectively.

### Result

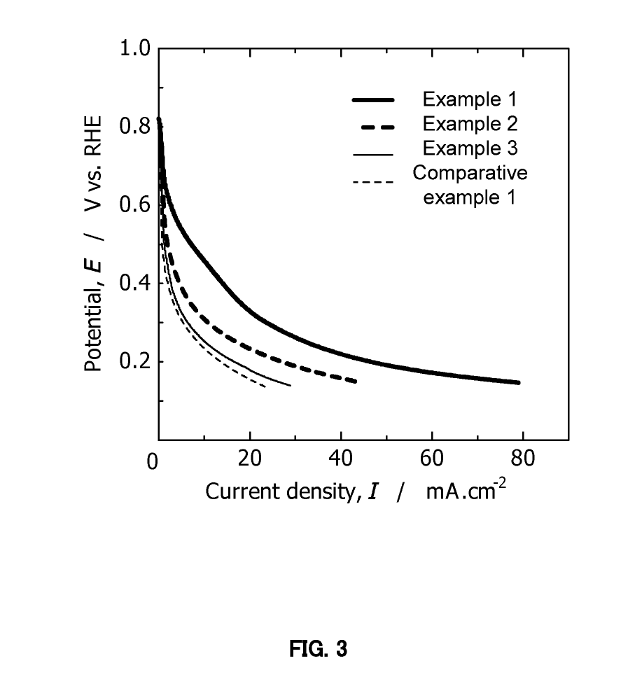

FIG. 3 illustrates power generation performances of the fuel cells fabricated using the MEA of the Examples 1-3 and Comparative example. The fuel cells of the Examples 1-3 had good power generation performance with no flooding. Particularly in the fuel cell of Example 1, power generation performance even in a low current region, in which a catalyst reaction was dominant, was significantly improved due to an increase of active reaction sites caused by arranging the electron conductive material on the catalyst surface. It was confirmed that the fuel cell of the Comparative example had a power generation performance inferior to that in the Examples 1-3 because the content ratio of the catalyst was so high that the electron conductive material is insufficiently arranged on the catalyst surface.

### INDUSTRIAL APPLICABILITY

As is presented above, it is possible to improve output performance of a fuel cell by the present invention since not only proton conductivity on a surface of the catalyst is improved but also active reaction sites are increased due to a sufficient contact between the catalyst and the carbon particles. Therefore, the present invention is preferably applied to a PEMFC (or PEFC), especially to a single fuel cell or fuel cell stack in a household fuel-cell system or a fuel-cell car etc.

What is claimed is:

1. A membrane electrode assembly comprising:
a polymer electrolyte membrane;
a pair of electrode catalyst layers; and
a pair of gas diffusion layers, wherein said polymer electrolyte membrane is interposed between said pair of electrode catalyst layers, and said pair of electrode catalyst layers are interposed between said pair of gas diffusion layers, wherein at least one of said pair of electrode catalyst layers contains an electron conductive material, a catalyst and a polymer electrolyte, and wherein at least in one of said pair of electrode catalyst layers a content ratio by weight of said catalyst is in the range of 0.1-3.0 with respect to 1.0 of said electron conductive material, and a content ratio by weight of said polymer electrolyte is in the range of 0.5-3.0 with respect to 1.0 of said electron conductive material.

2. The membrane electrode assembly according to claim 1, wherein said catalyst has a specific surface area in the range of 1-100 m²/g and an average particle diameter in the range from 20 nm to 3.0 μm.

3. The membrane electrode assembly according to claim 2, wherein said catalyst contains at least one transition metal of the group of Ta, Nb, Ti and Zr.

4. The membrane electrode assembly according to claim 3, wherein said catalyst is a product made by partially oxidizing a carbonitride of one transition metal of the group of Ta, Nb, Ti and Zr in the presence of oxygen.

5. The membrane electrode assembly according to claim 4, wherein said one transition metal is Ta.

6. A fuel cell comprising the membrane electrode assembly according to claim 5.

7. The membrane electrode assembly according to claim 3, wherein said electron conductive material has a specific surface area in the range of 100-2000 m²/g and an average particle diameter in the range of 20-100 nm.

8. The membrane electrode assembly according to claim 7, wherein said electron conductive material is carbon particles.

9. A fuel cell comprising the membrane electrode assembly according to claim 8.
